(19) United States
(12) Patent Application Publication
(10) Pub. No.: US 2014/0183105 A1
(43) Pub. Date: Jul. 3, 2014

(54) SERVING BOWL

(71) Applicants: LITA KAY VAN WAGENEN, SUPERIOR, CO (US); DALTON ALEXANDER VALETTE, SUPERIOR, CO (US)

(72) Inventors: LITA KAY VAN WAGENEN, SUPERIOR, CO (US); DALTON ALEXANDER VALETTE, SUPERIOR, CO (US)

(21) Appl. No.: 14/142,820

(22) Filed: Dec. 28, 2013

Related U.S. Application Data
(60) Provisional application No. 61/747,012, filed on Dec. 28, 2012.

(51) Int. Cl. B07B 1/02

(52) U.S. Cl. CPC B07B 1/02
USPC 209/680

(57) ABSTRACT

A serving bowl is configured to segregate un-popped popcorn kernels from popped popcorn kernels. The serving bowl has a bowl rim attached to an upper bowl section; wherein the bowl rim is sufficiently large to accommodate human fingers. A middle bowl section is attached to the upper bowl section. A lower bowl section is attached to the middle bowl section wherein the lower bowl section is perforated with sifting holes. A bowl base is attached to the lower bowl section and detachably coupled to a bottom lid forming a catch basin. The un-popped popcorn kernels and the popped popcorn kernels are accommodated in the serving bowl such that the un-popped popcorn kernels are segregated through the sifting holes and then stored in the catch basin.

### RELATED APPLICATION

This application claims priority to provisional patent application U.S. Ser. No. 61/747,012 filed on Dec. 28, 2012, the entire contents of which is herein incorporated by reference.

### BACKGROUND

The embodiments herein relate generally to kitchen utensils.

Prior to embodiments of the disclosed invention, un-popped popcorn kernels were an unwelcome surprise when eating popcorn. Not only were these kernels unwelcome, they presented health problems through possible choking and could cause numerous broken and chipped teeth for popcorn lovers. Also, when adding toppings such as butter and flavors to popcorn in traditional serving containers, the excess toppings collected in the bottom of the container leading to a sticky, gross mess, and over coating to the popcorn making it inedible and causing popcorn to be wasted. Embodiments of the disclosed invention solve this problem. The prior art includes: U.S. Pat. No. 5,332,102 issued to Sennett; U.S. Pat. No. 4,942,277 issued to Narberes; and U.S. Design Patent D468,168 issued to Gruenberg.

Sennett teaches a device for de-seeding popcorn. However, Sennett does not teach at least a tubular compartment mechanically coupled to the bottom face of the container; and a lid mechanically coupled to an open end of the tubular compartment.

Narberes teaches a microwave popcorn service bowl. However, Narberes does not teach at least a collapsible container configured to receive popcorn, kernels and toppings.

Gruenberg teaches a combination colander and container for separating un-popped popcorn kernels. However, Gruenberg does not teach at least a tubular compartment mechanically coupled to the bottom face of the container; and a lid mechanically coupled to an open end of the tubular compartment.

### SUMMARY

A serving bowl, developed in a variety of sizes, is configured to segregate un-popped popcorn kernels from popped popcorn kernels. The serving bowl has a bowl rim attached to an upper bowl section; wherein the bowl rim is sufficiently large to accommodate human fingers. A middle bowl section is attached to the upper bowl section. A lower bowl section is attached to the middle bowl section wherein the lower bowl section is perforated with sifting holes. A bowl base is attached to the lower bowl section and detachably coupled to a bottom lid forming a catch basin. The un-popped popcorn kernels and the popped popcorn kernels are accommodated in the serving bowl such that the un-popped popcorn kernels are segregated through the sifting holes and then stored in the catch basin.

A process for segregating un-popped popcorn kernels from popped popcorn kernels permits disposal of the un-popped popcorn kernels. The process contains the following steps, not necessarily in order: first, preparing popcorn comprising the popped popcorn kernels and the un-popped popcorn kernels in a popcorn pot. Then, pouring the popped popcorn kernels and the un-popped popcorn kernels into a serving bowl. The serving bowl being arranged as above. After that, rotating the serving bowl casing the un-popped popcorn kernels to fall to a bottom of the serving bowl. Next, collecting the un-popped popcorn kernels in the catch basin. Following that, removing the bottom lid from the bowl base. Then, disposing of the un-popped popcorn kernels.

In some embodiments, the middle bowl section can be made from a flexible material that minimizes container volume. The sifting holes can comprise seven sifting holes arranged in a circle and a single sifting hole centrally located in the circle. Each sifting hole can have a diameter between eight millimeters and ten millimeters. The bottom lid can be attached to a lid grip permitting easier removal of the bottom lid.

### BRIEF DESCRIPTION OF THE FIGURES

The detailed description of some embodiments of the invention is made below with reference to the accompanying figures, wherein like numerals represent corresponding parts of the figures.

FIG. 1 is a perspective view of the invention, shown in use

FIG. 2 is a perspective view of the invention in the expanded position

FIG. 3 is a perspective view of the invention in the collapsed position

FIG. 4 is a top view of the invention

FIG. 5 is an exploded view of the invention

FIG. 6 is a section view of the invention, taken along line 6-6 in FIG. 2.

FIG. 7 is a section view of the invention, taken along line 7-7 in FIG. 3.

FIG. 8 is a section view of the invention, illustrating the filling of the serving bowl

FIG. 9 is a top view of the invention, illustrating the sifting movement.

FIG. 10 is a section view of the invention, illustrating the removal of the bottom lid.

### DETAILED DESCRIPTION OF CERTAIN EMBODIMENTS

By way of example and referring to FIG. 1, serving bowl 10 comprises bottom lid 12 mechanically coupled to lid grip 14. Serving bowl 10 can be filled with popcorn 30 by inserting popcorn 30 within bowl rim 18.

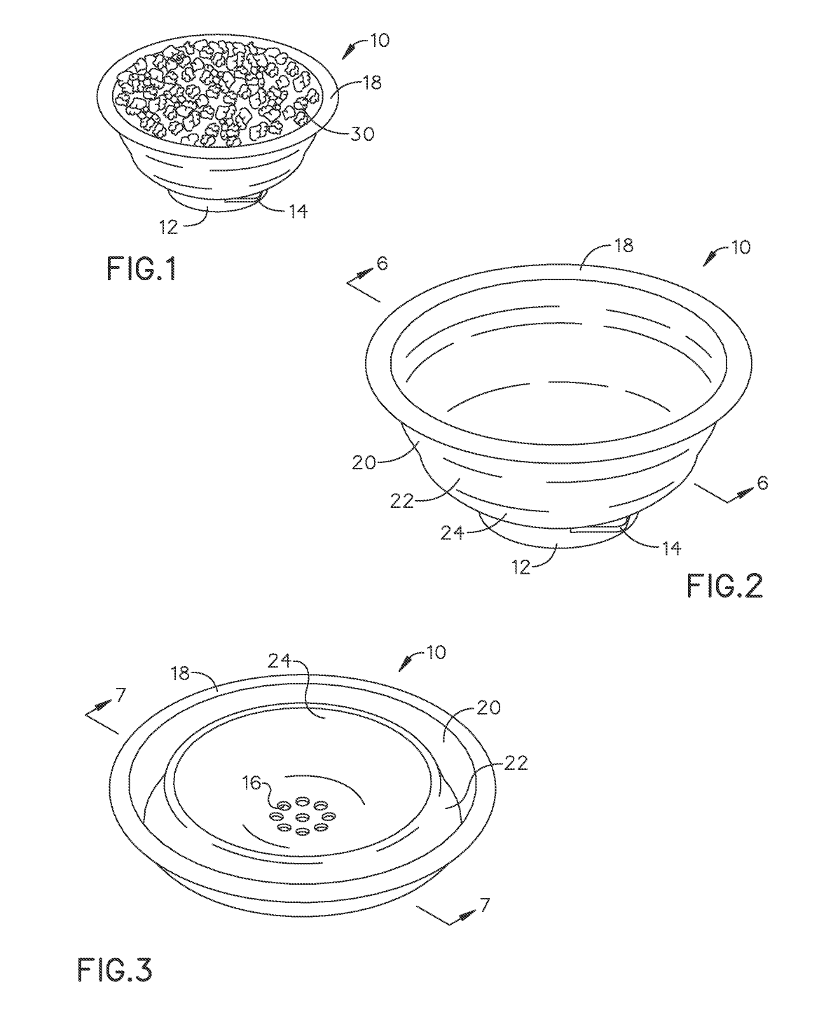

Turning to FIG. 2, bowl rim 18 is connected to upper bowl section 20. Upper bowl section 20 is connected to middle bowl section 22. Middle bowl section 22 is connected to lower bowl section 24. Bottom lid 12 is detachably coupled to lower bowl section 24.

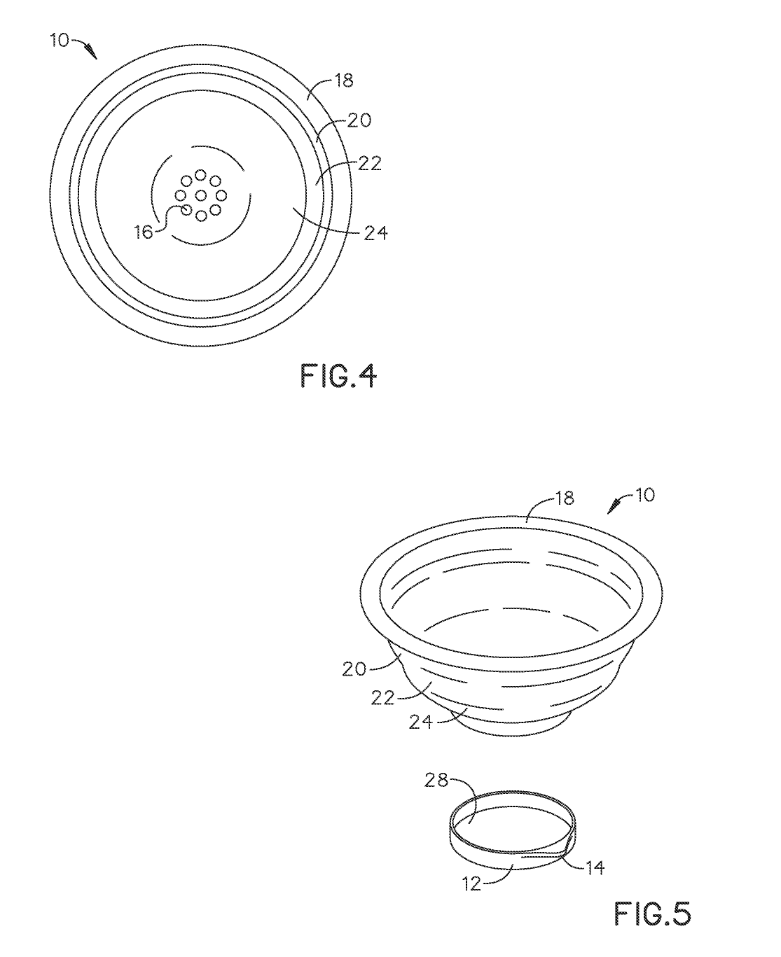

Turning to FIG. 3 and FIG. 4, upper bowl section 20 has an upper bowl section inner cross sectional area. Middle bowl section 22 has a middle bowl section inner cross sectional area. Lower bowl section 24 has a lower bowl section inner cross sectional area. These relative proportions are independent of size and, in fact, serving bowl 10 can be made in a variety of sizes.

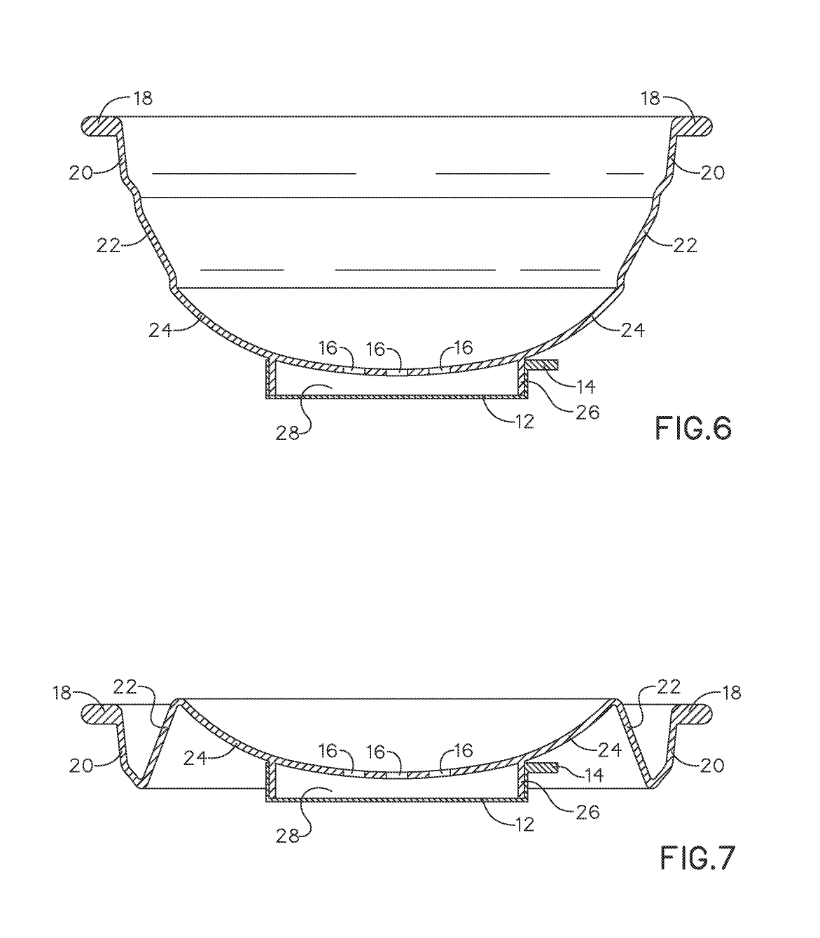

Turning to FIG. 5 and FIG. 6, a lower portion of lower bowl section 24 is perforated with sifting holes 16. There can be seven sifting holes 16 arranged in a circle with a single sifting hole 16 at the center of the circle. Sifting holes 16 should be sufficiently large to permit popcorn kernels to fall through sifting holes 16, but sufficiently small so that popcorn, when popped, does not fall through. Experimentation has indicated that each sifting hole 16 should have a diameter between 8 millimeters and 10 millimeters.

Lower bowl section 24 is mechanically coupled to bowl base 26. Bowl base 26 is detachably coupled to, and can be surrounded by lid 12 creating catch basin 28. To remove un-popped popcorn kernels 32 and excessive oil and flavoring, simply slide lid 12 from bowl base 26 as shown in more detail below.

Turning to FIG. 7, in one embodiment, the upper bowl section inner cross sectional area is greater than the middle bowl section inner cross sectional area. The middle bowl section inner cross sectional area is greater than the lower bowl section inner cross sectional area. This permits upper bowl section 20 to collapse and rest outside middle bowl section 22. Likewise, this permits middle bowl section 22 to collapse and rest outside lower bowl section 24.

To accomplish this, lower bowl section 24 should be made of a rigid material, such as a hard plastic. Upper bowl section 20 and bowl rim 18 can likewise be rigidly made from a hard plastic. However, middle bowl section 22 should be made from a flexible material, such as silicone and capable of being configured in an upward position (as shown in FIG. 6) which can maximize storage of popcorn or in a downward position which can minimize container volume for shelf storage.

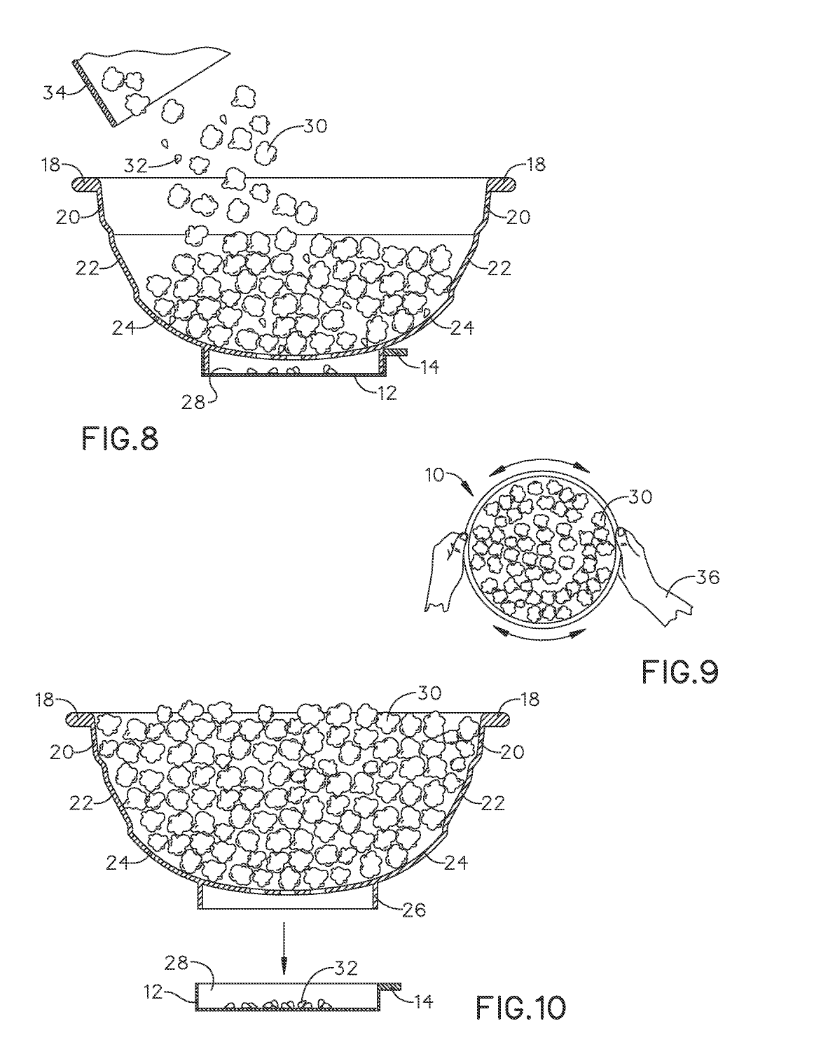

Turning to FIG. 8, FIG. 9 and FIG. 10, a process for segregating un-popped popcorn kernels 32 from contents dispensed from popcorn pot 34 contains the following steps, not necessarily in order. First, preparing popcorn comprising popped popcorn kernels 30 and un-popped popcorn kernels 32 in popcorn pot 34. Here, popcorn pot 34 is a generic term for any vessel capable of holding un-popped popcorn kernels 32 and popped popcorn kernels 30.

Next, pouring un-popped popcorn kernels 32 and popped popcorn kernels 30 into serving bowl 10 wherein serving bowl 10 further comprises: bowl rim 18 attached to upper bowl section 20. Upper bowl section 20 is attached to middle bowl section 22. Middle bowl section 22 is attached to lower bowl section 24. Lower bowl section 24 is perforated with sifting holes 16 and attached to bowl base 26. Bowl base 26 is detachably coupled to bottom lid 12 forming catch basin 28. Bottom lid 12 is attached to lid grip 14.

Then, user 36 rotates serving bowl 10. Note that bowl rim 18 is sufficiently large to accommodate human fingers. This utilizes the space between popped popcorn kernels 30 to cause un-popped popcorn kernels 32 to fall to the bottom of serving bowl 10. After that, collecting un-popped popcorn kernels 32 in catch basin 28. Following that, removing bottom lid 12 from bowl base 26. Finally, disposing of un-popped popcorn kernels 32.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A serving bowl configured to segregate un-popped popcorn kernels from popped popcorn kernels; the serving bowl comprising
a bowl rim attached to an upper bowl section; wherein the bowl rim is sufficiently large to accommodate human fingers;
a middle bowl section attached to the upper bowl section;
a lower bowl section attached to the middle bowl section wherein the lower bowl section is perforated with sifting holes
a bowl base attached to the lower bowl section and detachably coupled to a bottom lid forming a catch basin;
wherein the un-popped popcorn kernels and the popped popcorn kernels are accommodated in the serving bowl such that the un-popped popcorn kernels are segregated through the sifting holes and then stored in the catch basin.

2. The serving bowl of claim 1, wherein the middle bowl section is made from a flexible material that minimizes container volume.

3. The serving bowl of claim 1, wherein the sifting holes comprise seven sifting holes arranged in a circle and a single sifting hole centrally located in the circle.

4. The serving bowl of claim 1, wherein each sifting hole has a diameter between eight millimeters and ten millimeters.

5. The serving bowl of claim 1, wherein the bottom lid is attached to a lid grip permitting easier removal of the bottom lid.

6. A process for segregating un-popped popcorn kernels from popped popcorn kernels permits disposal of the un-popped popcorn kernels; the process comprising:
preparing popcorn comprising the popped popcorn kernels and the un-popped popcorn kernels in a popcorn pot;
pouring the popped popcorn kernels and the un-popped popcorn kernels into a serving bowl; wherein the serving bowl further comprises:
a bowl rim attached to upper bowl section
a middle bowl section attached to the upper bowl section;
a lower bowl section attached to the middle bowl section wherein the lower bowl section is perforated with sifting holes; and
a bowl base attached to the lower bowl section and detachably coupled to a bottom lid forming a catch basin;
rotating the serving bowl casing the un-popped popcorn kernels to fall to a bottom of the serving bowl;
collecting the un-popped popcorn kernels in the catch basin;
removing the bottom lid from the bowl base; and
disposing of the un-popped popcorn kernels.

7. The process of claim 6, further comprising: collapsing the middle bowl section in order to render the serving bowl portable.

8. The process of claim 6, wherein the sifting holes comprise seven sifting holes arranged in a circle and a single sifting hole centrally located in the circle.

9. The process of claim 6, wherein each sifting hole has a diameter between eight millimeters and ten millimeters.

10. The process of claim 6, wherein the bottom lid is attached to a lid grip permitting easier removal of the bottom lid.
